(19) United States
(12) Patent Application Publication
(10) Pub. No.: US 2005/0063264 A1
(43) Pub. Date: Mar. 24, 2005

(54) Information recording medium and its control method and information recording/reproducing method

(75) Inventors: Harukazu Miyamoto, Higashimurayama (JP); Koichiro Nishimura, Ebina (JP)

Correspondence Address: Stanley P. Fisher;Reed Smith LLP, Suite 1400, 3110 Fairview Park Drive, Falls Church, VA, 22042-4503, US

(73) Assignee: Hitachi, Ltd.

(21) Appl. No.: 10/773,404

(22) Filed: Feb. 9, 2004

(30) Foreign Application Priority Data
Sep. 22, 2003 (JP) 2003-329295

(51) Int. Cl. G11B 7/00

(52) U.S. Cl. 369/47.4

(57) ABSTRACT

An information recording medium includes data concerning a maximum linear velocity (V1max) and a minimum linear velocity (V1min) at a first location on the medium and a maximum linear velocity (V2max) and a minimum linear velocity (V2min) at a second location on the medium, are recorded at a predetermined location on said medium, and at the first and second locations both of which are located at different locations on the medium, performing selectively CLV/CAV (Constant Linear Velocity/Constant Angular Velocity) control or alternatively a CLV/CAV-hybrid control.

### CROSS-REFERENCE TO RELATED APPLICATION

This application relates to and claims priority from Japanese Patent Application No. 2003-329295, filed on Sep. 22, 2003, the entire disclosure of which is incorporated herein by reference.

### BACKGROUND OF THE INVENTION

1. Field of the Invention

The present invention generally relates to a high-speed information recording system for recording and/or reproducing information at a high speed by using an energy beam. More particularly, the present invention relates to an information recording medium different in a relative moving speed of the energy beam at locations on the recording medium, capable of removing the medium, and applicable to a removable type disk-like recording medium. The present invention also relates to a method of recording or reproducing information on or from the information recording medium.

2. Description of the Related Art

First, description will be made of an exemplary or conventional optical recording apparatus by reference to FIGS. 3 and 5 of the accompanying drawings, in which FIG. 3 is a block diagram showing schematically a configuration of a conventional optical recording/reproducing apparatus.

Referring to FIG. 3, a light emanated from a laser source 25 incorporated in an optical head 2 as a constituent part thereof and having a wavelength of about 660 nm in the case where a DVD-RAM is employed as the information recording medium is collimated to a substantially parallel optical beam 22 by means of a collimating lens 24. The optical beam 22 is then projected onto an optical disk 11 through an objective lens 23, whereby an optical spot 21 is formed on the optical disk 11. Subsequently, the optical beam 22 reflected from the optical disk 11 is guided to a servo-dedicated detector 26 and a signal detector 27 through a beam splitter 28, a holographic element 29 and others. The signals output from these detectors undergo addition/subtraction processings for deriving a servo signal such as a tracking error signal, a focus error signal or the like. The servo signal is then inputted to a servo circuit which is designed to control the positions of an objective lens actuator 31 and the optical head 2 as a whole on the basis of the tracking error signal and/or the focus error signal as derived, for thereby positioning the optical spot 21 at a desired or target recording/reproducing zone. A summation signal output from the signal detector 27 is input to a signal reproduction block 41. The input signal then undergoes a digitizing processing after a filtering processing and a frequency equalize processing by means of signal processing circuits incorporated in the signal processing block 41. The digital signal resulting from the digitizing processing is subsequently processed by an address detecting circuit and a decoder circuit. On the basis of the address signal detected by the address detecting circuit, the position of the optical spot 21 on the optical disk 11 is arithmetically determined by a microprocessor, whereon the optical head 2 and hence the optical spot 21 are so controlled as to be positioned at a desired or target unitary recording zone (hereinafter also referred to as the target recording sector) by an automatic position control means.

Now, it is assumed that a command is issued to the microprocessor from a host system, indicating the recording of information. Then, the microprocessor receives recording data (i.e., data to be recorded) from the host system for storing it in a memory while activating the automatic position control means to position the optical spot 21 at a location in the target recording sector. The microprocessor then confirms on the basis of an address signal supplied from the signal reproduction block 41 that the optical spot has been positioned at the target recording sector without fail, whereon the microprocessor records the data stored in the memory in the target recording sector on the optical disk by controlling a laser driver and others.

When the optical disk medium is inserted into the optical recording apparatus of the structure described above, the optical recording apparatus firstly reads out medium control data recorded previously in a specific zone on the recording medium (e.g. in a lead-in area located at a radially inner side of a user data area in the case of the DVD). From the control data, information concerning a recording linear velocity of the recording medium and waveform information such as a recording power, recording pulse width are extracted for controlling the rotation speed of the recording medium for actual recording/reproduction of information on the basis of the linear velocity data extracted from the control data.

Set forth as the linear velocities in the control data on the conventional optical disk are a maximum linear velocity (Vmax), an ordinary linear velocity and a minimum linear velocity (Vmin) among others. By way of example, in the case of a DVD-RW medium, it is set forth or stated that the minimum linear velocity Vmin is 3.49 m/s with the maximum linear velocity Vmax being 8.55 m/s. Since this medium can be used in the above-mentioned linear velocity range, it is possible to perform the recording by resorting to a CAV (Constant Angular Velocity) control at a constant rotation speed (rpm), as illustrated in FIG. 5 of the accompanying drawings. More specifically, there is illustrated in FIG. 5 a linear velocity designated by reference numeral 201 as a function of radial position of the recording medium of the disk-like recording medium in the case of the CAV control. The user data area radially extends over a range from 24 mm to 58.75 mm. As can be seen in FIG. 5, the CAV control can be carried out in such a manner that the linear velocity in the user data area is confined within the range between the maximum linear velocity Vmax and the minimum linear velocity Vmin. In that case, by controlling the rotation speed to be 1389 rpm, such control of the linear velocity can be realized that the linear velocity at the radius of 24 mm is 3.49 m/s while the linear velocity at the radius of 58.75 mm is 8.55 m/s.

At this juncture, it should be mentioned that the recording medium now of concern is also susceptible to a CLV (Constant Linear Velocity) control in addition to the CAV control mentioned above. In the case of the CLV control, the rotation speed of the recording medium is also so controlled that the linear velocity falls within the range between the maximum linear velocity Vmax and the minimum linear velocity Vmin.

By way of example, in JP-A-2003-059053, it is described in conjunction with a phase-change type recording medium destined for CAV recording (Constant Angular Velocity recording) that information can be recorded at the minimum recordable linear velocity and the maximum recordable linear velocity. Further, there is disclosed in JP-A-07-073470 a recording medium having a first area or zone in which the information can be recorded at a fist linear velocity and a second area in which the information can be recorded at a second linear velocity.

However, with the conventional control data recording method or scheme, there arises a problem when the recording speed of the optical disk is to be further increased, that is, the linear velocity becomes extremely high in the radially inner zone of the disk, making it practically difficult or impossible to increase the recording speed. More specifically, as can be seen in FIG. 7 of the accompanying drawings, the disk rotation speed (rpm) becomes very high at the radially inner zone when the CLV control is adopted. At such a high speed rotation, vibration will occur in the disk drive apparatus under the influence of the centrifugal force, being accompanied with occurrence of offensive noise, and in the worst case, the disk might unwantedly be damaged under the effect of the centrifugal force. Moreover, test and check cannot be conducted at the high linear velocity in the radially inner zone, giving rise to an additional problem. Furthermore, in view of the impossibility to increase the rotation speed (rpm) at the radially inner zone, the CAV control is indispensable in order to increase the rotation speed (rpm) beyond that of the eight-speed DVD drive. For effectuating the CAV control, the compatible linear velocity range has to be broadened. However, for realizing the wide linear velocity range correspondingly over the whole surface of the disk, high cost will be incurred in the development and manufacturing of the recording medium, presenting a problem.

### SUMMARY OF THE INVENTION

In the light of the state of the art described above, it is an object of the present invention to provide a high-speed recording medium which can positively ensure interchangeability and which can be manufactured inexpensively.

In view of the above and other objects which will become apparent as the description proceeds, there is provided according to several aspects of the present invention the means or measures which will be stated below.
(1) Firstly, there is proposed according to an aspect of the present invention related to a disk-like information recording medium having at least a concentrical or spiral information track for recording information by irradiating with an energy beam moving on and along the track relative to the information recording medium, wherein data concerning a maximum linear velocity (V1max) and a minimum linear velocity (V1min) at a first location on the information recording medium and a maximum linear velocity (V2max) and a minimum linear velocity (V2min) at a second location on the information recording medium, the second location differing from the first location, are previously recorded at a predetermined location on the information recording medium.

With the information recording medium or disk of the structure described above, the rotation of the disk can easily be so controlled on the basis of the data of the maximum linear velocities and the minimum linear velocities recorded at the predetermined location that the energy beam can move at the linear velocity which conforms with the characteristics of the disk. Accordingly, even in the case where the recording medium according to the invention is exchangeably used among a plurality of optical recording/reproducing apparatuses, it is possible to control the rotation of the recording medium on the recording conditions conforming with the characteristics of the recording medium. Thus, interchangeability of the recorded information can be enhanced. Further, owing to the capability of controlling the disk rotation, high-seed record evaluation (e.g. inspection or check at shipping) of the high-speed recording compatible medium can be performed at the radially inner zone of the disk.
(2) In the information recording medium described above, it is proposed according to another aspect of the present invention that the aforementioned predetermined location is defined within a control data zone in which the recording medium control data are previously recorded. By recording the data concerning the linear velocity information in the control data zone as mentioned above, the media manufacturer can record the linear velocity data in conformance with the characteristics of the recording medium. Besides, there is no fear that the data might inadvertently be erased after the shipping of the recording medium. Ordinarily, the control data are impressed on the recording medium substrate in the form of embossed pits or the like upon manufacturing the recording medium. Accordingly, there is no possibility of the data being lost. However, some recording/reproducing systems are so arranged that the control data can also be written on the recording medium in the state inserted in the recording/reproducing apparatus, such as exemplified by a write-once optical disk. In that case, the media control data to be transmitted to the recording/reproducing apparatus from the media manufacturer is generally provided as the physical media data recorded in the form of wobble grooves. In that case, it is desirable to record the linear velocity data in the media control data zone. In any case, the data zone which is allocated only for the media manufacturer should preferably be made use of. At this juncture, it should also be mentioned that the predetermined location need not physically be destined for the read-only location, but a rewritable area such as a disk information zone may be used to this end dedicatedly or jointly, substantially to the similar effect.
(3) Further, in the information recording medium described above, it is proposed according to another aspect of the present invention that at least one of the undermentioned conditions is to be satisfied:
   r1<r2, and
   V1max<V2max or
   V1min<V2min
      where r1 represents the radial distance of the first location from the center of the disk-like information recording medium,
   r2 represents the radial distance of the second location from the center of the disk-like information recording medium,
   V1max represents the maximum linear velocity at the first location,
   V2max represents the maximum linear velocity at the second location,
   V1min represents the minimum linear velocity at the first location, and
   V2min represents the minimum linear velocity at the second location.

To say in another way, either the minimum linear velocity or the maximum linear velocity at the radially inner zone is lower than the corresponding one at the radially outer zone.

With the measures mentioned above, such a problem that the high-speed rotation is difficult to realize at the radially inner zone because the rotation speed at the radially inner zone is high as compared with the rotation speed at the radially outer zone for a same linear velocity when high-speed recording/reproduction is performed can satisfactorily be coped with. In other words, the recording medium mentioned just above is advantageously suited for the high-speed information recording. In particular, the constant angular velocity (CAV) control with the constant rotation speed (rpm) can easily be realized.
(4) In the information recording media described above, it is further proposed according to yet another aspect of the present invention that the conditions that r1<r2 and that V1min/r1<V2max/r2 be satisfied.

Since the minimum rotation speed (rpm) at the radially inner side or zone of the disk-like recording medium is given by V1min/r1/2π while the maximum rotation speed (rpm) at the radially outer side or zone is given by V2max/r2/2π, the relational expression mentioned above means that the minimum rotation speed (rpm) at the radially inner zone is equal to or lower than the maximum rotation speed (rpm) at the radially outer side or zone. Accordingly, in the case of the recording medium on which the linear velocity conditions which meet the above-mentioned relational expression are recorded, the CAV (Constant Angular Velocity) control can be performed with the constant rotation speed (rpm) over the range from the radially innermost zone to the radially outermost zone. In this conjunction, it should be mentioned that the CAV (Constant Angular Velocity) control provides an advantage that energy loss due to variation of the rotation speed can be avoided because the rotation speed (rpm) is allowed to be consistently constant and thus the recording/reproducing operation can be carried out at a high speed.
(5) In the information recording medium mentioned above, it is further proposed according to still another aspect of the present invention that the condition that V1max<V2min be additionally satisfied. Owing to this feature, the CAV (Constant Angular Velocity) control with the constant linear velocity cannot be carried out because the linear velocity at the radially inner zone is constantly lower than the linear velocity at the radially outer zone. In other words, so long as the condition mentioned just above is satisfied, the recording medium dedicated only for the CAV (Constant Angular Velocity) control is provided which is controlled consistently in the same recording control mode even among the different recording apparatuses, whereby interchangeability for the recording/reproduction can be enhanced.

(6) In the information recording medium mentioned above, it is proposed according to a further aspect of the present invention that at least some of recording/reproducing conditions corresponding to the maximum linear velocities (Vmax) and the minimum linear velocities (Vmin) at the first and second locations, respectively, are previously recorded together with the linear velocity information at the predetermined location on the recording medium. In this conjunction, the recording conditions mean the recording power, the pulse width and others.

By set forth the recording conditions separately for the linear velocities in the radially inner zone and the radially outer zone, respectively, there can be provided the recording medium whose characteristics in the radially inner zone differ from the characteristics at the radially outer zone. By way of example, it is possible to manufacture such a recording medium that exhibits higher recording sensitivity in the radially outer zone when compared with that of the radially inner zone. With such recording medium, the recording power in the radially outer zone can be suppressed from increasing even in the CAV (Constant Angular Velocity) recording control where the linear velocity is high in the radially outer zone. Thus, there is made available the recording medium which is excellently suited for the high speed recording/reproduction.

Besides, since the recording control in which difference of the recording characteristics between the radially inner zone and the radially outer zone of the disk-like recording medium is compensated for can be realized, reliability of the recorded signal quality can be enhanced.
(7) Furthermore, according to a further aspect of the present invention, there is proposed a method of controlling an information recording medium on which information is recorded or from which recorded information reproduced by irradiating with an energy beam moving on and along a track relative to the information recording medium, wherein data concerning a maximum linear velocity (V1max) and a minimum linear velocity (V1min) at a first location on the information recording medium and a maximum linear velocity (V2max) and a minimum linear velocity (V2min) at a second location on the information recording medium, the second location which differs from the first location, are recorded at a predetermined location on the information recording medium. According to the control method, the linear velocity data recorded at the predetermined location on the recording medium are reproduced in precedence to the information recording or reproduction for the purpose of controlling the relative moving speed of the energy beam so that the linear velocity at the first location lies between the maximum linear velocity (V1max) and the minimum linear velocity (V1min) while the linear velocity at the second location being confined between the maximum linear velocity (V1max) and the minimum linear velocity (V2min).

By performing the control in accordance with the linear velocity data recorded on the recording medium, as described above, information can be recorded in conformance with the conditions intended by the media manufacturer, whereby the information recording of stabilized quality can be realized. Thus, the recorded signal quality, i.e., reliability of the recorded information, can be enhanced. Besides, interchangeability of the recording medium among a plurality of recording/reproducing apparatuses is also enhanced.
(8) In the information recording medium control method mentioned above, it is proposed according to still further aspect of the present invention that the control of the relative moving speed of the energy beam is carried out by controlling the rotation speed of the information recording medium. Owing to this feature, the linear velocity control can be facilitated.
(9) Additionally, in the information recording medium control method mentioned above, the present invention proposes that as the method of controlling the rotation speed for information recording, a constant angular velocity (CAV) control with the rotation speed (rpm) being constant, a constant linear velocity (CLV) control with the linear velocity being constant or a combination of the constant angular velocity (CAV) control and the constant linear velocity (CLV) control is selected, wherein the control method to be adopted is determined on the basis of result of reproduction of the data concerning the maximum linear velocities and the minimum linear velocities as recorded at the aforementioned predetermined location.

With the control method mentioned just above, the maximum recording/reproducing performance can be realized through appropriate combination of the recording medium and the recording/reproducing apparatus. Besides, a plurality of recording control modes can exchangeably be selected in dependence on applications and/or user's demand. In that case, it is however preferred to carry out the control such that the range of the maximum linear velocity and the minimum linear velocity recorded on the recording medium is not exceeded.

As is apparent from the foregoing, there is provided according to the present invention the high-speed recording compatible medium which makes it possible to perform information recording/reproduction in conformance with the recording conditions intended by the media manufacturer, whereby the stable quality of the signal recorded can be ensured with the interchangeability of the recording medium among a plurality of the recording/reproducing apparatuses being enhanced.

Other objects, features and advantages of the invention will become apparent from the following description of the embodiments of the invention taken in conjunction with the accompanying drawings.

### BRIEF DESCRIPTION OF THE DRAWINGS

FIG. 1 is a view showing an arrangement or disposition of recording zones on a recording medium according to the present invention;

FIG. 2 is a view for graphically illustrating, by way of example, recording linear velocity ranges of the recording medium and a recording control method according to an embodiment of the present invention;

FIG. 3 is a block diagram showing, by way of example, a configuration of a conventional optical recording/reproducing apparatus known heretofore;

FIG. 4 is a view for graphically illustrating, by way of example, recording linear velocity ranges of the recording medium and a recording control method according to an embodiment of the present invention;

FIG. 5 is a view for graphically illustrating, by way of example, a recording linear velocity range of a conventional recording medium and the recording control method;

FIG. 6 is a view for graphically illustrating recording/reproducing characteristics of a recording medium according to an embodiment of the present invention;

FIG. 7 is a view for graphically illustrating a relation between a rotation speed (rpm) and a radial position in a CLV (Constant Linear Velocity) control;

FIG. 8 is a view showing some of media control data of a recording medium according to an embodiment of the present invention;

FIG. 9 is a schematic cross-sectional view of a recording medium according to an embodiment of the present invention;

FIG. 10 is a view for graphically illustrating recording waveforms according to an embodiment of the present invention;

FIG. 11 is a view for graphically illustrating, by way of example, recording linear velocity ranges of a recording medium and a recording control method according to an embodiment of the present invention;

FIG. 12 is a view for illustrating schematically an example of a method of manufacturing a recording medium according to an embodiment of the present invention;

FIG. 13 is a view for graphically illustrating recording/reproducing characteristics of a recording medium according to an embodiment of the present invention; and

FIG. 14 is a block diagram showing a configuration of a recording apparatus according to an embodiment of the present invention.

### DETAILED DESCRIPTION OF THE EMBODIMENTS

Embodiment 1

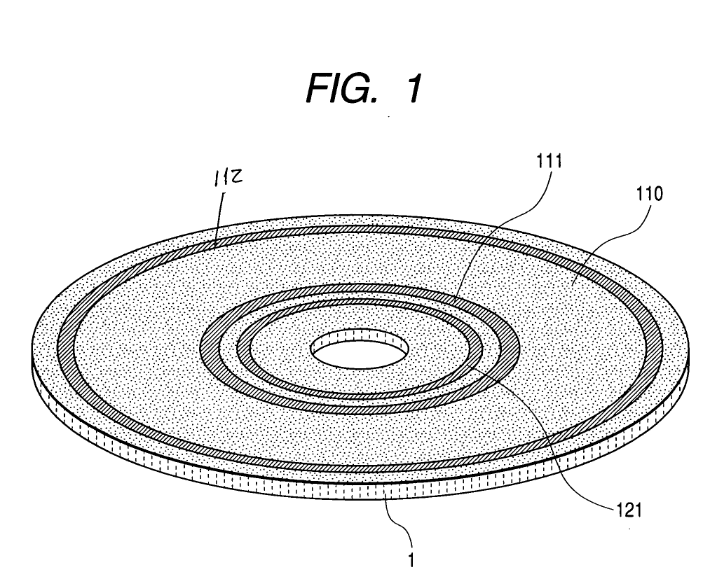

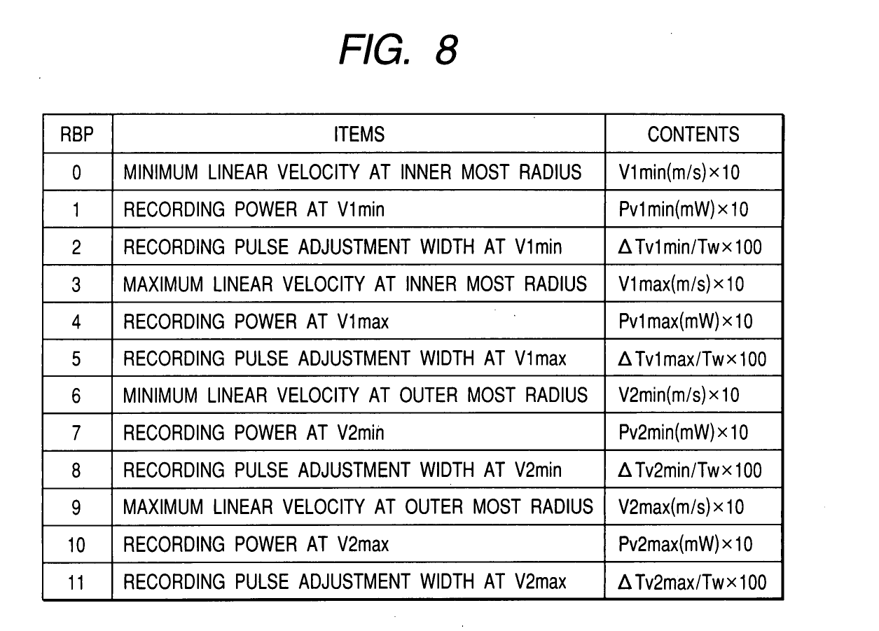

FIG. 1 is a view showing schematically an arrangement or disposition of recording zones on a recording medium 1 according to a first embodiment of the present invention. Referring to the figure, maximum linear velocities and minimum linear velocities for a radially innermost zone 111 and a radially outermost zone 112, respectively, which belong to a user data area 110 on a disk-like recording medium are recorded in a control data zone 121 which is located at a lead-in portion at the radially inner side of the user data area 110. Some of the recorded contents of the control data are shown in FIG. 8. More specifically, FIG. 8 shows extractively a portion of the control data zone 121 where information concerning the linear velocities mentioned above are set forth or recorded.

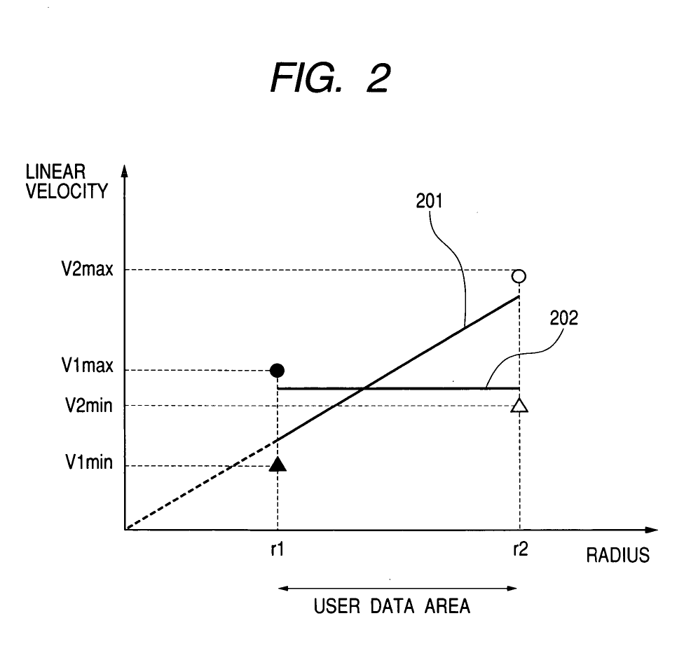

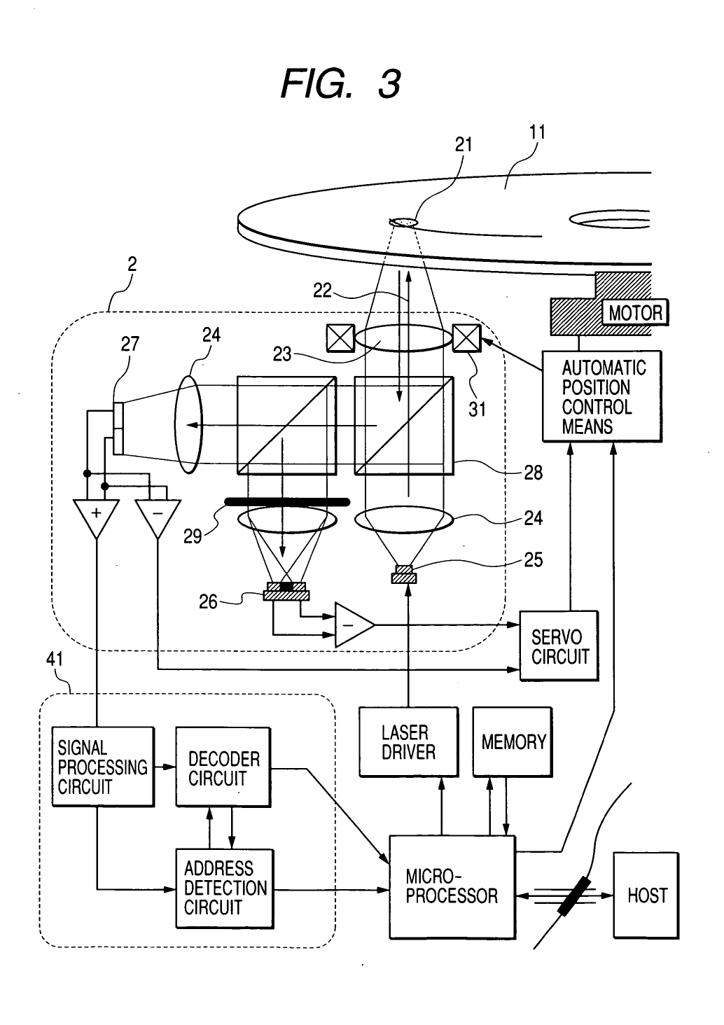

Referring to FIG. 8, in a column labeled “RBP”, there are entered relative byte positions (RBPs), wherein each entry is represented by one byte, i.e., eight bits. At the locations where RBP=0, RBP=1 and RBP=2, there are entered the information concerning the minimum linear velocity at the radially innermost zone. More specifically, at the location RBP=0, a value resulting from multiplication of the minimum linear velocity V1min (m/s) (V1min×10) is entered as an unsigned integer. By way of example, the velocity of 12.3 m/s is entered in the form of “123”, i.e., “7Bh”. Similarly, at the location RBP=1, the value of the recording power Py1 min (mW) at the minimum linear velocity V1min multiplied by “10” is entered as the unsigned integer. Further, at the location RBP=2, the value obtained by dividing a recording pulse adjustment width ΔTV1min for the minimum linear velocity V1min at the radially innermost zone by a channel clock frequency Tw corresponding to the above-mentioned velocity and subsequently multiplied by “10” is entered in as a signed integer. Similarly, at the locations RBP=“3” to RBP=“5”, RBP=“6” to RBP=“8” and RBP=“9” to RBP=“11”, there are recorded or entered in the similar format the information concerning the maximum linear velocity V1max at the radially innermost zone, the information concerning the minimum linear velocity V2 min at the radially outermost zone and the maximum linear velocity V2max at the radially outermost zone, respectively. In the case of the recording medium according to the instant embodiment of the invention, it is assumed that V1min=5 m/s, V1max=10 m/s, V2min=8 m/s and V2max=15 m/s are recorded as the linear velocities information. Incidentally, the control data contains in addition to the information about the linear velocities such as mentioned above the information concerning the disk species or type (e.g. recording/reproduction-destined disk, reproduction-dedicated disk and so forth), information concerning the size of the disk (e.g. 120 mm, 80 mm, etc.), information concerning the recording density, information concerning the addresses of the record locations and others. At this juncture, it should also be mentioned that in the recording medium according to the instant embodiment of the invention, the radius of the radially innermost zone from the center of the disk is 24 mm, while that of the radially outermost zone from the center of the disk is 58 mm, and this information is also entered as the control data. Relation between the maximum/minimum linear velocities recorded on the recording medium and the user data area is graphically illustrated in FIG. 2. In this figure, a solid circle and a solid triangle represent the maximum and minimum linear velocities, respectively, at the radially innermost zone, whereas a blank circle and a blank triangle represent the maximum and minimum linear velocities, respectively, at the radially outermost zone. The recording medium according to the instant embodiment of the invention is susceptible to undergo either the CAV control or the CLV control or combination thereof. In FIG. 2, the radial position dependency of the linear velocity in the case of the CAV control is represented by a line segment 201 while that of the linear velocity in the case of the CLV control is represented by a line segment 202. Incidentally, in FIG. 2, r1 represents the radius (radial distance) of the radially innermost zone or location from the center of the disk, and r2 represents the radius of the radially outermost zone or location from the center of the disk. Since the rotation speed (rpm) is constant in the case of the CAV control, the linear velocity is in proportion to the radius. In FIG. 2, it is assumed that the rotation speed in the CAV control is 2387 rpm with the linear velocity being 6 m/s at the radially innermost zone or location while it is 14.5 m/s at the radially outermost zone or location. On the other hand, in the CLV control, the linear velocity is controlled to be 9 m/s with the rotation speed (rpm) at the radially innermost location being 3581 rpm while the rotation speed (rpm) at the radially outermost location is 1482 rpm. It is apparent that in addition to the CLV/CAV control conditions illustrated in FIG. 5, the CAV control can be carried out within the rotation speed range from 1989 rpm at which the linear velocity at the radially innermost zone or location assumes the minimum linear velocity of 5 m/s up to 2470 rpm at which the linear velocity at the radially outermost zone or location assumes 15 m/s. Similarly, the CLV control can be carried out within the range from the minimum linear velocity of 8 m/s at the radially outermost location to the maximum linear velocity of 10 m/s at the radially innermost location.

In this conjunction, it is to be noted that although the rotation speed is restrained to a relatively low rotation speed of around 2000 rpm in the case of the CAV control, the linear velocity which determines the data transfer rate is maintained within the range of 12 m/s to 15 m/s at the radially outermost zone or location. On the other hand, in the case of the CLV control, although the linear velocity is maintained at an intermediate level within the range of 8 m/s to 10 m/s, the rotation speed at the radially inner zone is relatively as high as about 3500 rpm.

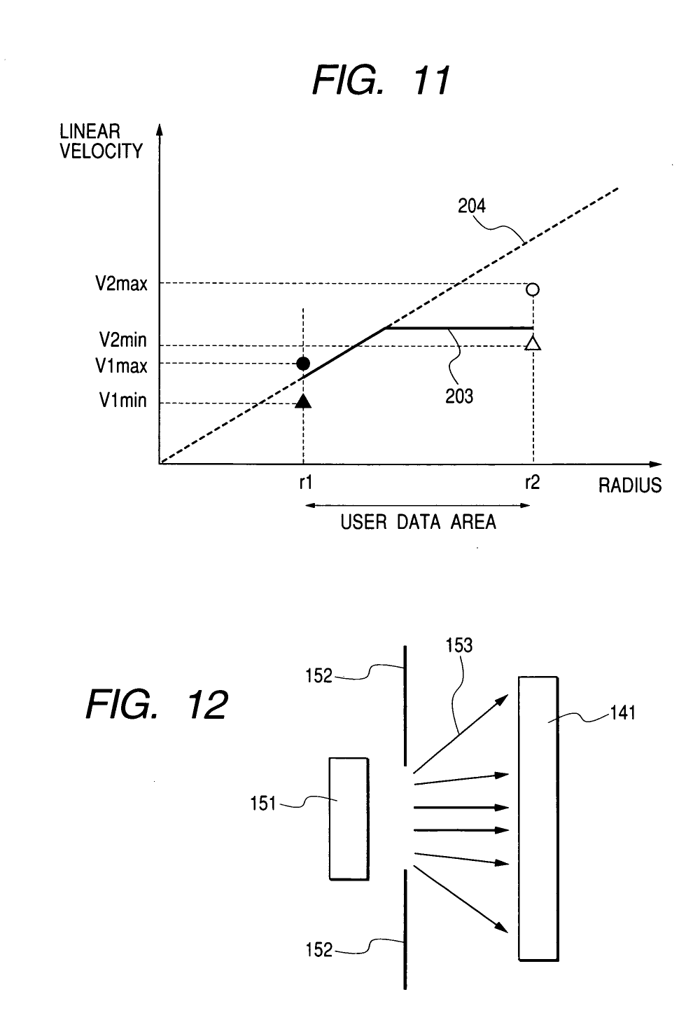

Accordingly, when importance or priority is put on the performance at the radially inner zone, the CLV control should preferably be adopted, whereas when importance is put on the high-speed performance and the low power consumption, the CAV control should be adopted in place of the CLV control. In other words, the CLV control and the CAV control can exchangeably be effectuated. Besides, in order to establish compatibility between the high-speed performance at both the radially inner zone and the radially outer zone, combination of the CLV control and the CAV control (CLV/DAV-hybrid control) may be adopted, as will be described later on in conjunction with another embodiment of the invention by reference to FIG. 11. Thus, it is possible to select the optimum mode in dependence on the applications (e.g. AV recording/reproduction, data recording/reproduction, etc.) and the environment in which the recording medium or disk is employed (e.g. mobile, desk-top apparatus, etc.).

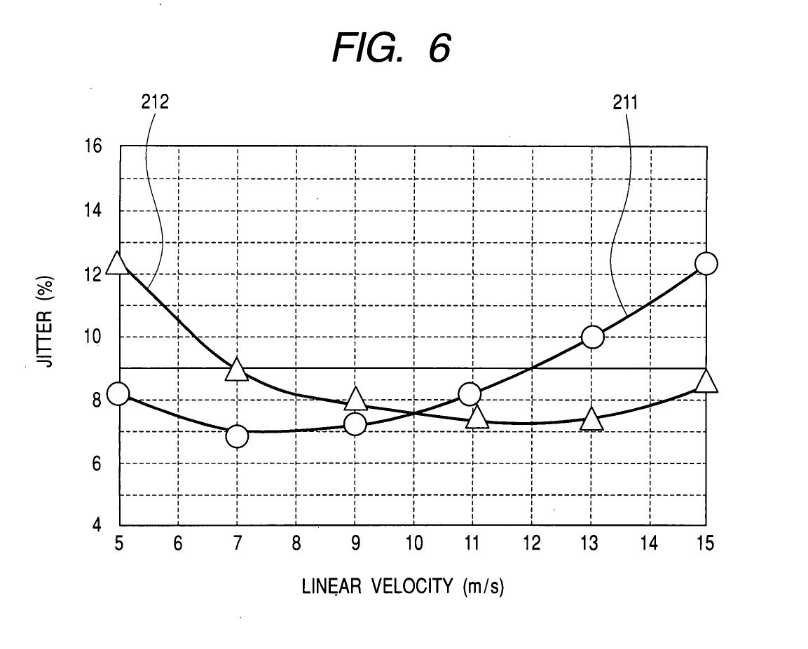

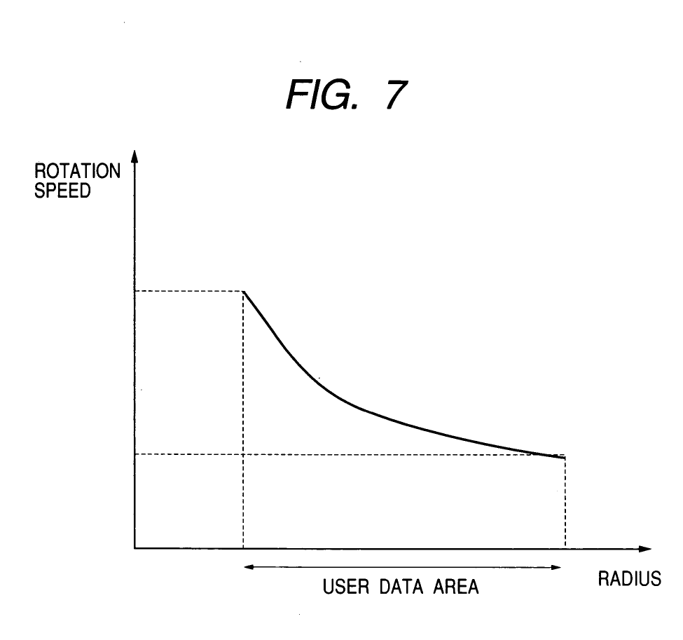

FIG. 6 is a view for graphically illustrating dependency of the reproduced signal quality (also referred to as the jitter characteristic) on the recording linear velocity according to the instant embodiment of the invention. As can be seen in the figure, there occur deviations between the characteristic 211 in the radially inner zone and the characteristic 212 in the radially outermost zone of the recording medium. The deviations are ascribable to revolution and rotation of the recording medium or disk within the manufacturing apparatus upon manufacturing thereof. In more concrete, deviations or differences of the characteristic between the radially inner and outer zones of the disk are ascribable to the difference of the moving speed between the radially inner and outer zones internally of the manufacturing apparatus. According to the present invention incarnated in the instant embodiment, the characteristic deviations mentioned above are taken into consideration in advance in manufacturing the recording medium or disk such that the jitter characteristic is of high quality at the low linear velocity in the radially inner zone, while in the radially outer zone, the jitter characteristic is excellent at the high linear velocity. As a result of this, there can be realized such satisfactory characteristic that the jitter is suppressed to less than 9% inclusive at the linear velocity within the range of 5 m/s or lower to 12 m/s in the radially inner zone and in the range of 7 m/s to 15 m/s or higher in the radially outer zone. In this conjunction, it is noted that the ranges of the maximum/minimum linear velocities recorded in the control data zone is encompassed by the range within which the jitter characteristic is satisfactory. To say in another way, within the ranges of the maximum/minimum linear velocities set forth in the control data, the recording/reproduction can be realized with an adequate margin.

The recording power and recording pulse width control information set forth in association with the linear velocities indicates the recommendable laser waveform for the recording on the recording medium. The recording waveform is such as illustrated in FIG. 10. Referring to the figure, for a length nT of an NRZI signal to be recorded (denoted by reference numeral 221), the recording waveform is of a (n−1)-type multi-pulse waveform which is short of the NRZI signal length by one pulse length. The recording pulse adjustment width ΔT is represented by increment or decrement from TW/2 of the recording pulse width.

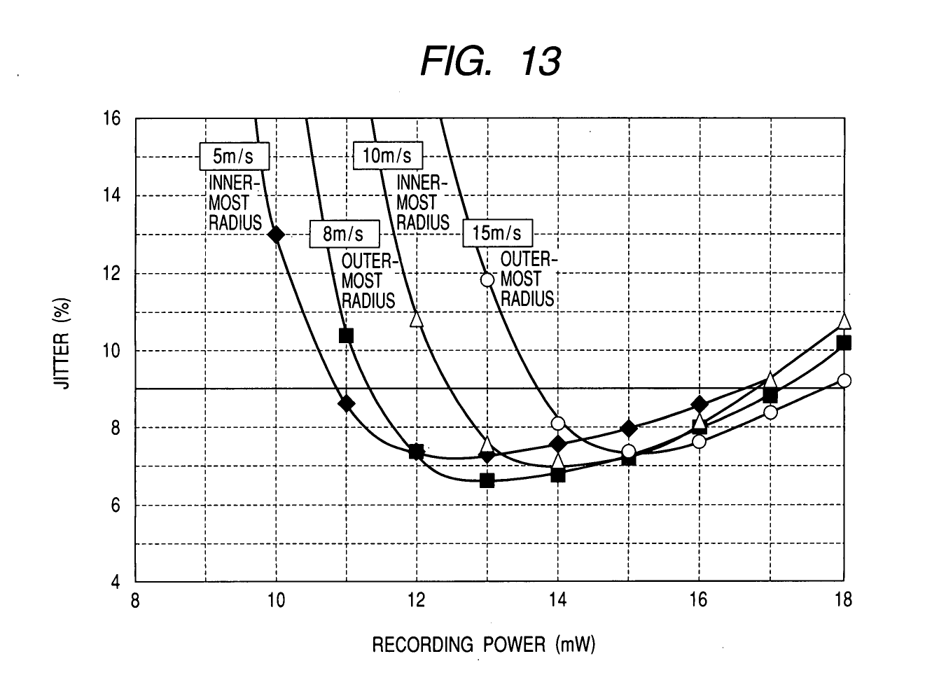

FIG. 13 is a view for graphically illustrating relations between the recording power and the jitter at the maximum and minimum linear velocities at the radially inner and outer zones, respectively. Referring to this figure, the optimum recording power differs in dependence on the linear velocity. Accordingly, the recording powers at which the jitters become minimum on the individual linear velocity conditions are recorded in the control data zone. 1

At this juncture, it should be added that the recording medium according to the instant embodiment of the invention is a phase-change rewritable recording medium designed for the recording/reproduction with the wavelength of 405 nm and NA of 0.85, wherein the track pitch is 0.32 μm with the bit pitch being 0.12 μm. Accordingly, in the CAV control, the maximum linear velocity Vmax of 15 m/s at the radially outermost zone is equivalent to the data transfer rate of 125 Mbps (=15 m/s/0.12 μm), which means that the high-rate data transfer can be realized in the CAV recording.

Embodiment 2

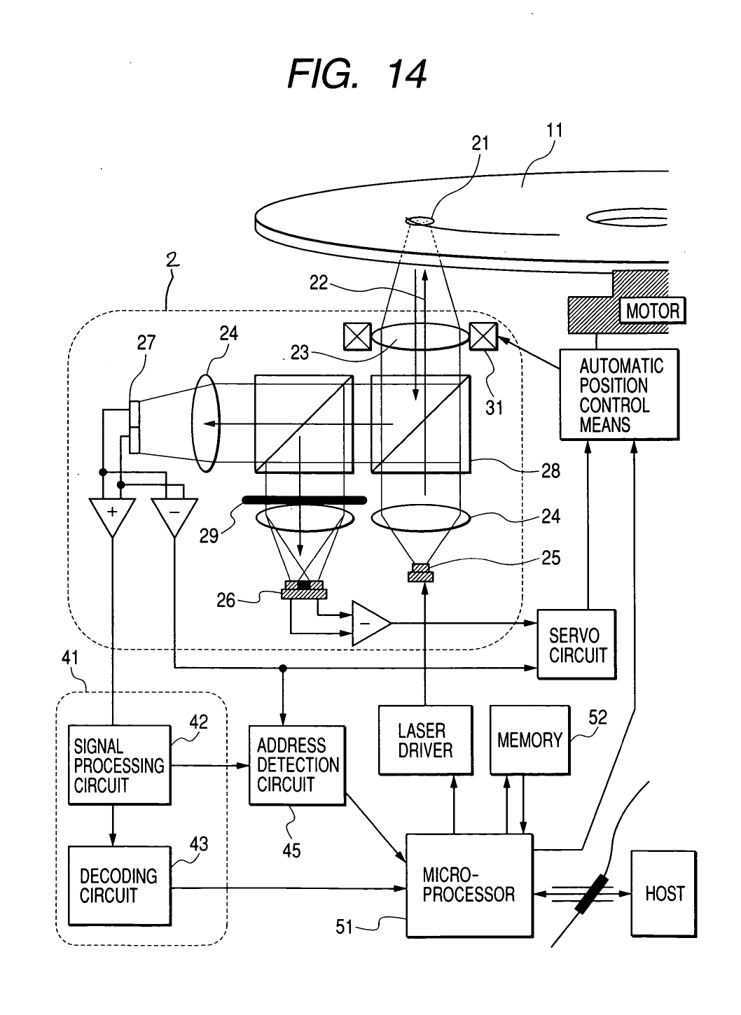

An example of the optical recording apparatus according to an embodiment of the present invention will be described by reference to FIG. 14.

FIG. 14 is a block diagram showing schematically a configuration of the optical recording apparatus according to an embodiment of the present invention. Referring to FIG. 14, light emanated from a laser source 25 implemented as a part of an optical head 2 and having a wavelength of about 405 nm is collimated to a substantially parallel optical beam 22 through a collimating lens 24. The optical beam 22 is projected onto an optical disk 11 through an objective lens 23 to form a spot 21 on the optical disk 11. Subsequently, the optical beam 22 reflected from the optical disk 11 is guided to a servo-dedicated detector 26 and a signal detector 27 through the recording medium of a beam splitter 28, a holographic element 29 and others. The signals outputted from the detectors undergo addition/subtraction processings to be transferred to a servo signal such as a tracking error signal, a focus error signal or the like to be subsequently inputted to a servo circuit. The servo circuit is designed to control the positions of an objective lens actuator 31 and the optical head 2 as a whole on the basis of the tracking error signal and/or the focus error signal as obtained for thereby positioning the optical spot 21 at a desired or target recording/reproducing location. A summation signal outputted from the detector 27 is inputted to a signal reproduction block 41. The input signal is then subjected to a digitize processing in succession to filtering and frequency equalize processings by means of a signal processing circuit 42. The digital signal resulting from the digital processing is then processed by a decoder circuit 43. Address information can be obtained by an address detection circuit 45 from a wobble signal which in turn is derived from the differential output of the signal detector 27. However, for the purpose of ensuring enhanced reliability for the address detection, a recorded information reproduction signal derived from the summation signal is also used in combination.

When the disk is inserted or when the optical recording apparatus or system is powered on, the optical recording system firstly executes the processing for discriminatively identifying the species or type of the recording medium. The system according to the present invention is imparted with the recording/reproducing function of CDs and DVDs in addition to the high-speed high-density recording media compatible with the blue light source. For this reason, the recording medium type identifying processing is firstly executed in the optical recording system to determine to which of the high-speed high-density recording medium, the CD and the DVD the inserted recording medium corresponds. Of course, the identifying method as adopted will differ in dependence on the individual systems actually employed. In the system according to the instant embodiment of the present invention, the species or type of the recording medium is roughly estimated on the basis of the reflectivity and the analog characteristics of the reproduced signal such as the focus error signal and the like to thereby perform the control of gain, etc., which is followed by projecting the optical spot on the region of the disk substrate in which the physical information of the recording medium is recorded for reproducing control data to thereby finally determine the type of the recording medium on the basis of the contents of the control data. In that case, when the recording medium according to the present invention has been inserted, the linear velocity information is acquired from the control data to store the linear velocity relevant information in a memory 52. A microprocessor 51 then determines the rotation control mode (CLV/CAV) for the recording on the basis of the linear velocity relevant information stored in the memory 52 to thereby validate the rotation control mode (CLV/CAV) as determined. In the case where it is decided that the recording is possible in a plurality of control modes, then the control mode to be validated is selected in accordance with the command issued from the host (application) or alternatively the default preference control mode is activated in the case where no command is available from the host. As the preference control modes, there can be mentioned a CLV/CAV hybrid control with preference being put on the performance in the case of half-height type machines and the CAV control of low power consumption for slim type machines which are designed for use in the mobiles.

The parameters for the recording conditions such as the recording powers and the recording pulse widths for the various linear velocities at the various radial positions in the respective control modes are determined on the basis of the values set forth in the control data zone by resorting to the linear interpolation. In actuality, the linear interpolation is performed in two arithmetic processing steps. In the first step, the conditions between the maximum linear velocities at the radially innermost and outermost locations or zones are determined through the linear interpolation, while the conditions between the minimum linear velocities at the radially innermost and outermost locations or zones are determined through the linear interpolation, which is then followed by the second step in which the recording at the radially intermediate zone is determined on the basis of the minimum/maximum linear velocities determined in the first step through the linear interpolation. Needless to say, the order or sequence of the arithmetic processings executed in the first and second steps may be reversed, substantially to the same effect. Further, in place of using intactly or straightforwardly the data derived from the control data zone, it is possible to allow the data derived from the control data zone to be learned as the initial value(s).

Embodiment 3

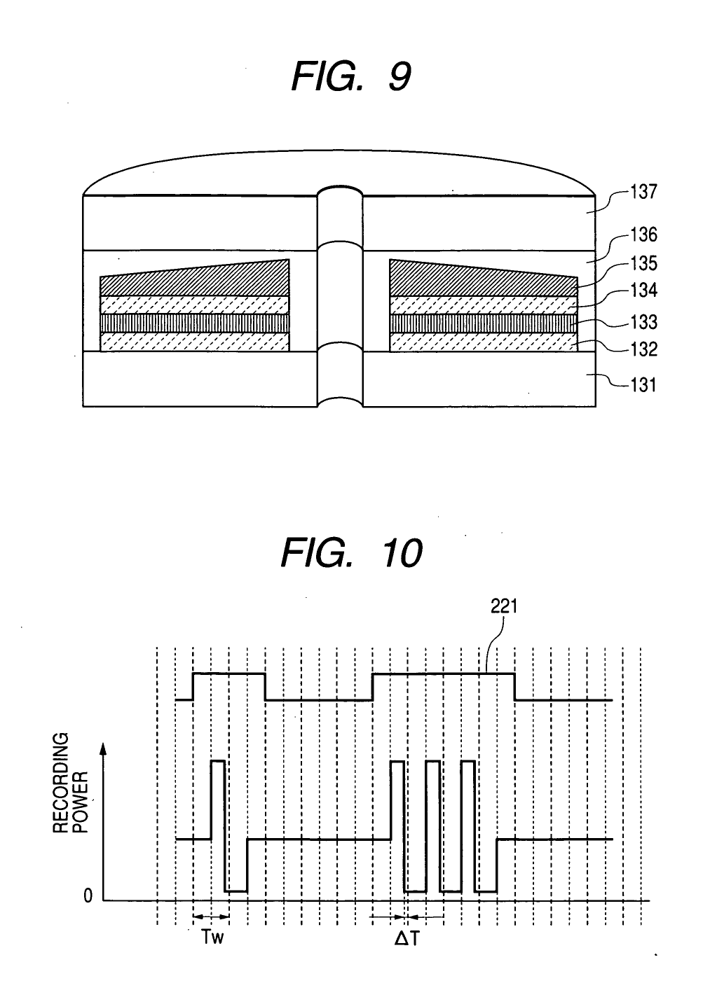

FIG. 9 is a schematic cross-sectional view of the recording medium according to a third embodiment of the invention. The recording medium now of concern is a rewritable DVD medium designed for recording/reproducing with a laser beam having a wavelength of 650 nm at NA of 0.6. Referring to FIG. 9, the recording medium includes a subassembly composed of a substrate 131 on which a dielectric layer 132, a phase-change recording layer 133, a dielectric layer 134 and a metal reflective layer 135 are deposited in this order. The subassembly mentioned above is bonded to a dummy substrate 137 by a UV curing resin 136. At this juncture, it is to be mentioned that the thickness of the metal reflective layer 135 is gradually decreased in the direction from the radially innermost zone or location toward the radially outermost zone or location. FIG. 12 is a view for illustrating an example of the method of manufacturing the metal reflective layer 135 by changing the thickness thereof in the manner mentioned above. Referring to FIG. 12, sputtered particles 153 emitted from a sputtering target 151 are deposited on the substrate 141 through the recording medium of a shield 152. In that case, by employing the shield 152 having a through-hole formed in a region which corresponds to a radially inner zone or region of the substrate 141, the sputtered particles are deposited with a large thickness at the radially innermost zone or location, which thickness gradually decreases in the direction toward the radially outermost zone or location of the substrate 141.

Measurement of the recording characteristics of the recording medium described above at the radially inner and outer zones thereof has shown that excellent recording characteristics are ensured at the linear velocity within the range of 10 m/s to 20 m/s in the radially inner zone and at the linear velocity within the range of the 25 m/s to 45 m/s in the radially outer zone. As can be seen, in the case of the recording medium now of concern, the linear velocity range in the radially outer zone is shifted remarkably to the higher speed range when compared with the linear velocity range in the radially inner zone, and no overlap is found between the linear velocity range in the radially inner zone and the linear velocity range in the radially outer zone.

The reason why the excellent recording characteristics are obtained at the low linear velocity in the radially inner zone and at the high linear velocity in the radially outer zone as mentioned above can be explained as follows. In the radially inner zone or region, the metal reflective layer 135 is thick as described previously. Consequently, heat or thermal capacity is large with the recording sensitivity being low while the rate of thermal diffusion through the metal reflective layer is high. Thus, by scanning the metal reflective layer with a high-power laser beam at a low linear velocity over a relatively extended time, there can be realized the superior recording characteristics owing to the balanced high-rate cooling effect ascribable to the high-rate thermal diffusion. On the other hand, in the radially outer zone or region of the recording medium, the metal reflective layer is formed thin. Consequently, heat or thermal capacity is small with the recording sensitivity being high while the rate of thermal diffusion through the metal reflective layer is low. Thus, by scanning the metal reflective layer with a low-power laser beam at a high linear velocity for a relatively short time, there can be realized the excellent recording characteristics owing to rapid change of the heat quantity applied to the recording medium. In the case of the recording medium according to the first embodiment of the invention, the optimum recording power increases as the recording rate becomes higher, as can be seen in FIG. 13. By contrast, in the case of the recording medium according to the instant embodiment, any appreciable difference is not found in the recording power between the radially inner zone or region where the recording rate is low and the radially outer zone or region where the recording rate is high.

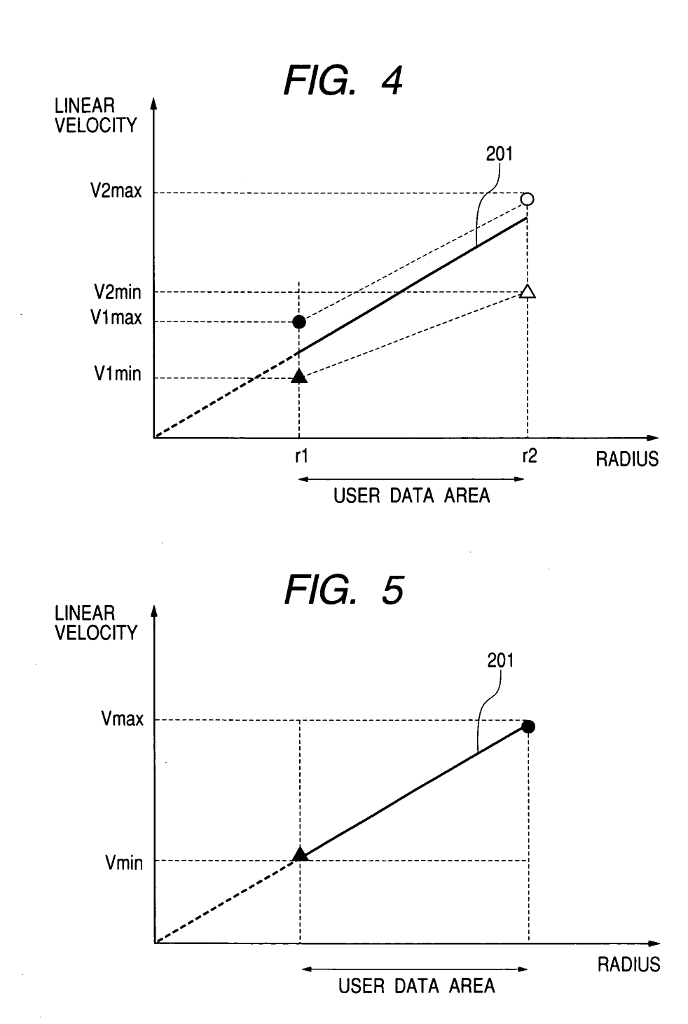

FIG. 4 shows the compatible linear velocity ranges for the radially inner and outer zones of the recording medium according to the instant embodiment of the invention and a method of controlling the linear velocity through the CAV control. A line segment 201 shown in FIG. 4 represents the linear velocity in the CAV control mode when the rotation speed of the recording medium is 5800 rpm, wherein the linear velocity at the radially innermost zone or location is ca. 14.6 m/s with the linear velocity at the radially outermost zone or location is ca. 35.3 m/s. Since the linear velocity of the one-speed DVD drive is ca. 3.5 m/s, the above-mentioned linear velocities at the radially innermost zone or location and the radially outermost zone or location are substantially equivalent to the quad-speed and the ten-speed, respectively.

Since there is no overlap between the linear velocity range for the radially inner zone and the linear velocity range for the radially outer zone in the case of the recording medium according to the instant embodiment of the invention, it is impossible to carry out the information recording/reproduction through the CLV control, which however represents practically no demerit in respect to the performance when compared with the recording medium for the CLV/CAV-combinational or -hybrid use, because the CLV control can not be effectuated for the super-high speed recording/reproduction in any case. The recording medium according to the instant embodiment is rather excellent than the recording medium for the CLV/CAL-combinational use in respect to the manufacturing cost and the interchangeability because the recording medium applicable to the system which demands a wide linear velocity range for the CAV control can be manufactured relatively easily.

Embodiment 4

FIG. 11 is a view for illustrating graphically the compatible linear velocity range of the recording medium according to a fourth embodiment of the present invention. The recording medium now concerned is a high-speed recording medium compatible with a blue laser of the wavelength of 405 nm and NA of 0.65.

With regard to the compatible linear velocity ranges, the linear velocity in the radially inner zone ranges from 10 m/s to 20 m/s while the linear velocity in the radially outer zone ranges from 25 m/s to 45 m/s. The linear velocity data mentioned above are recorded in the control data zone. With the recording medium now concerned, it is impossible to perform the CLV control because of absence of overlap between the linear velocity range in the radially inner zone and the linear velocity range in the radially outer zone. Further, because the ratio of the minimum linear velocity in the radially inner zone to the radius is greater than the ratio of the maximum linear velocity in the radially outer zone to the radius, it is also impossible to adopt the CAV control. Thus, for the recording medium according to the instant embodiment of the invention, the CLV/CAV hybrid control described hereinbefore in conjunction with FIG. 11 is employed. In the case of the recording medium now under consideration, the CAV control is performed at the disk rotation speed of 6800 rpm in the radially inner zone defined between the radii of 24 mm and 35 mm. In FIG. 11, a dotted line 204 represents a relation between the radius and the linear velocity on the assumption that the disk is rotated at the rotation speed of 6800 rpm. Since the maximum linear velocity for the radially outer zone is exceeded, the CAV control mentioned above can not be adopted in the radially outer zone. Thus, according to the teaching of the present invention incarnated in the instant embodiment, the CLV control at the linear velocity of 25 m/s is adopted in the zone which exceeds the radius of 35 mm. In both the radially inner zone and the radially outer zone, the recording/reproduction can be carried out at the linear velocity between the maximum linear velocity and the minimum linear velocity, as indicated by a solid line curve 203. As another control scheme, the CAV control at the rotation speed of 6800 rpm can be performed in the zone up to the radius of 42 mm. In that case, in the zone located outside beyond the radius of 42 mm, the CLV control at the linear velocity of 30 m/s is performed. Incidentally, the CLV/CAV hybrid scheme according to the present invention may be adopted for the recording media described hereinbefore in conjunction with the first and third embodiments, respectively. In that case, the maximum performance (transfer rate) can be ensured by effecting the CAV control for the radially inner zone at the limit rotation speed of the spindle while performing the CLV control for the radially outer zone at the maximum linear velocity for the radially outermost zone.

At this juncture, it should be mentioned that application of the present invention is never restricted to the embodiments described in the foregoing. It goes without saying that the teachings of the present invention can equally be applied to the write-once recording medium in addition to the rewritable recording medium with advantageous effects similar to those mentioned hereinbefore because limitation ascribable to physical mechanism is imposed to the compatible recording linear velocity range in the write-once recording medium as well.

Further, instead of employing intactly the data recorded in the control data zone as the recording conditions, optimum conditions may be determined through learn control by making use of the data recorded in the control data zone as the initial value. Further, by adopting a method of determining the interim conditions through interpolation, there can conveniently be realized the recording control of high accuracy.

Furthermore, the control data zone in which the linear velocity ranges are recorded is not necessarily dedicated to the reproducing operation. By way of example, the compatible linear velocity ranges may be recorded on the basis of the results of measurement of the compatible linear velocity ranges as performed by the media manufacturer. Besides, the compatible linear velocity ranges of the recording medium may be determined by the recording/reproducing apparatus itself through the learning process upon initial operation, whereon the compatible linear velocity range as learned is recorded in a disk identification zone (DIZ) on the recording medium together with the drive ID so that the disk rotation control can be carried out on the basis of the information recorded in the disk information zone when the same recording medium is inserted.

It should be further understood by those skilled in the art that although the foregoing description has been made on embodiments of the invention, the invention is not limited thereto and various changes and modifications may be made without departing from the spirit of the invention and the scope of the appended claims.

1. An information recording medium on which information is recorded or from which recorded information is produced by irradiating with an energy beam moving on/along a track relative to said medium,
wherein at a first location and a second location both of which are located at different locations on said medium, data concerning a maximum linear velocity (V1max) and a minimum linear velocity (V1min) at said first location and a maximum linear velocity (V2max) and a minimum linear velocity (V2min) at said second location, are recorded at a predetermined location on said medium.

2. An information recording medium according to claim 1,
wherein said predetermined location on said medium lies in a control data zone in which data concerning said medium are recorded.

3. An information recording medium according to claim 1,
wherein at least one of undermentioned conditions is satisfied:
r1<r2, and
V1max<V2max or
V1min<V2 min
where r1 represents a radial distance of said first location from a center of said medium and
r2 represents a radial distance of said second location from said center of said medium.

4. An information recording medium according to claim 3,
wherein conditions that r1<r2 and that V1min/r1<V2max/r2 are satisfied, where r1 represents a radial distance of said first location from a center of said medium and
r2 represents a radial distance of said second location from said center of said medium.

5. An information recording medium according to claim 3,
wherein condition that V1max<V2 min is additionally satisfied.

6. An information recording medium according to claim 1,
wherein at least some of
recording/reproducing conditions corresponding to said maximum linear velocities (Vmax) and said minimum linear velocities (Vmin) at said first and second locations, respectively, are recorded at said predetermined location.

7. A method of controlling an information recording medium on which information is recorded or from which recorded information is reproduced by irradiating with an energy beam moving on/along a track relative to said medium, at a first location and a second location both of which are located at different radial locations on said medium, wherein data concerning a maximum linear velocity (V1max) and a minimum linear velocity (V1min) at said first location and a maximum linear velocity (V2max) and a minimum linear velocity (V2 min) at said second location, are recorded at a predetermined location on said medium, said method comprising the steps of:
reproducing said data in precedence to recording or reproduction of the information;
controlling the relative moving speed of said energy beam such that the linear velocity at said first location lies between said maximum linear velocity (V1max) and said minimum linear velocity (V1min); and
controlling the relative moving speed of said energy beam such that the linear velocity at said second location lies between said maximum linear velocity (V1max) and said minimum linear velocity (V2 min).

8. An information recording medium control method according to claim 7,
wherein control of said relative moving speed of said energy beam is realized by controlling a rotation speed of said medium.

9. An information recording medium control method according to claim 8,
wherein a method of controlling the rotation speed for information recording is performed by one of a control method selected from a group consisting of a constant angular velocity (CAV) control with a rotation speed (rpm) being constant, a constant linear velocity (CLV) control with a linear velocity being constant and a combination of said constant angular velocity (CAV) control and said constant linear velocity (CLV) control, and
wherein the control method to be actually employed is determined on the basis of result of reproduction of said data.

10. An information recording medium control method according to claim 7,
wherein the linear velocities at other locations than said first and second locations are determined through a linear interpolation between said minimum linear velocity (V1min) at said first location and said minimum linear velocity (V2min) at said second location and between said maximum linear velocity (V1max) at said first location and said maximum linear velocity (V2max) at said second location.

11. An information recording medium control method according to claim 7,
wherein said information recording medium includes a reflective layer, thickness of which is gradually decreased from a radially inner side of said medium toward a radially outer side of said medium, and
wherein a constant angular velocity (CAV) control is adopted for controlling a rotation of said medium.

12. An information recording medium control method according to claim 7,
wherein a rotation of said medium is controlled through a constant angular velocity (CAV) control at a radially inner zone of said medium while being controlled through a constant linear velocity (CLV) control at a radially outer zone of said medium.

13. An information recording medium control method according to claim 7,
wherein said data are set as initial values with information of previously recorded control data, and optimum conditions are determined by a learning procedure.

14. An information recording medium control method according to claim 7,
wherein said data are determined on the basis of jitter.

15. An information recording method of recording information on an information recording medium by irradiating with an energy beam moving on/along a track relative to said medium,
said method comprising the steps of:
reading data concerning a maximum linear velocity (V1max) and a minimum linear velocity (V1min) at a first location on said medium and a maximum linear velocity (V2max) and a minimum linear velocity (V2 min) at a second location on said medium, at said first and second locations both of which are located at different locations on said medium, and said data being recorded at a predetermined location on said medium; and
recording the information on said medium by controlling a relative speed between said medium and said energy beam on the basis of said data.

16. An information reproducing method of reproducing information from an information recording medium recorded the information by irradiating with an energy beam moving on/along a track relative to said medium,
said method comprising the steps of:
reading data concerning a maximum linear velocity (V1max) and a minimum linear velocity (V1min) at a first location on said medium and a maximum linear velocity (V2max) and a minimum linear velocity (V2 min) at a second location on said medium, at said first and second locations both of which are located at different locations on said medium, and said data being recorded at a predetermined location on said medium; and
reproducing the information recorded on said medium by controlling a relative speed between said medium and said energy beam on the basis of said data.
